(19) United States
(12) Patent Application Publication
(10) Pub. No.: US 2026/0339754 A1
(43) Pub. Date: Oct. 29, 2026

(54) RECOVERY DEVICE AND METHOD FOR RESOLVING SYSTEM DEADLOCK

(71) Applicant: LG ELECTRONICS INC., Seoul (KR)

(72) Inventors: Jungwoo LEE, Seoul (KR); Jinseok IM, Seoul (KR); Kangduek KWON, Seoul (KR)

(73) Assignee: LG ELECTRONICS INC., Seoul (KR)

(21) Appl. No.: 19/120,180

(22) PCT Filed: Oct. 12, 2022
(86) PCT No.: PCT/KR2022/015370

§ 371 Date: Apr. 10, 2025

(51) Int. Cl. G06F 9/52; G06F 11/07; G06F 11/14

(52) U.S. Cl. CPC G06F 9/524; G06F 11/0739; G06F 11/0757; G06F 11/0793; G06F 11/1441

(57) ABSTRACT

A recovery device for resolving a system deadlock according to an embodiment may comprise: a recovery block that generates and transmits a deadlock occurrence signal when a system deadlock occurs; a deadlock manager block that transmits an interrupt, starts an internal timer, and waits for a specific operation process to be completed upon receiving the deadlock occurrence signal from the recovery block; and a central processing unit (CPU) operatively connected to a system bus and configured to receive the interrupt from the deadlock manager block and clear the interrupt while in operation. When the timer expires, the deadlock manager block determines that the CPU is in deadlock and can transmit a deadlock resolution command to the recovery block.

### TECHNICAL FIELD

This specification relates to a recovery device and method for resolving a system deadlock. A particular implementation relates to a recovery device and method for resolving a system deadlock in a system of a vehicle.

### BACKGROUND ART

A vehicle may perform wireless communication services with other vehicles, nearby objects, infrastructure, or a base station. In this regard, various communication services may be provided using long term evolution (LTE) communication, fifth generation (5G) communication, or WiFi communication technology.

In relation to this, application areas of a system-on-chip (SoC) have recently expanded. Meanwhile, the system-on-chip refers to an implementation of, into a single chip, a complex system mounted with several functional blocks (intellectual property (IP)) that perform various functions and processors.

These various functional blocks and processors mounted on the system-on-chip operate by transmitting and receiving necessary data with each other. When a problem occurs in at least one of the functional blocks, a deadlock state in which a whole system stops may occur.

When a problem in one functional block causes the whole system to become inoperable, this may result in a great loss from a perspective of the whole system. There is a growing need for technologies that prevent deadlocks in which the whole system stops due to problems in functional blocks.

Meanwhile, a main reason why the whole system becomes inoperable is a halting of operation of a central processing unit (CPU) that drives the system. In relation to this, this is because response signals for commands requested by the CPU are not transmitted due to a system deadlock.

### DISCLOSURE OF INVENTION

### Technical Problem

One aspect of this specification is to solve the aforementioned problems and other drawbacks. Therefore, to obviate those problems, an aspect of this specification is to provide a recovery device and method for resolving a system deadlock.

Another object of this specification is to provide a recovery device and method for resolving an issue such that a response signal to commands requested by a central processing unit (CPU) is not transmitted due to a system deadlock caused by halting of an operation of the CPU.

Another object of this specification is to resolve an inoperable state of a CPU independently by a system even when a deadlock state occurs.

Another object of this specification is to provide a recovery method and device that enables a CPU to attempt system recovery.

### Solution to Problem

To achieve these and other advantages and in accordance with the purpose of the present disclosure, as embodied and broadly described herein, there is provided a recovery device configured to resolve a system deadlock in a vehicle, the recovery device including: a recovery block that generates and transmits a deadlock occurrence signal when a deadlock in a system occurs; a deadlock manager block that transmits an interrupt and operates an internal timer to wait for a particular operation to be completed, upon receiving the deadlock occurrence signal from the recovery block; and a central processing unit (CPU) operably coupled to a system bus and configured to receive the interrupt from the deadlock manager block and clear the interrupt in an operational state. The deadlock manager block may determine that the CPU is in a deadlock when the internal timer expires, and transmit a deadlock resolution command to the recovery block.

As an embodiment, when the deadlock resolution command is received, the recovery block may resolve a deadlock of a corresponding interface associated with the deadlock resolution command and control a corresponding function block associated with the deadlock resolution command to be isolated from the system bus.

As an embodiment, the corresponding function block may be a first recovery block operably connected to a first master block among a plurality of master blocks. When it is determined that the deadlock of the first recovery block is resolved and the CPU is operable, the CPU may perform a system recovery service routine and clear the interrupt of the deadlock manager block.

As an embodiment, the deadlock manager block may determine that the CPU is still in a deadlock, when the deadlock of the first recovery block is resolved but the interrupt of the deadlock manager block is not cleared and the internal timer of the deadlock manager block expires again. The deadlock manager block may transmit a second deadlock resolution command to a second recovery block to which a second deadlock signal has been transmitted, and control the internal timer to re-operate. The second recovery block may be operably coupled to a second master block among the plurality of master blocks

As an embodiment, until the CPU completes the performing of the system recovery service routine, the deadlock manager block may repeatedly transmit a plurality of deadlock resolution commands to a plurality of recovery blocks. When the plurality of deadlock resolution commands are transmitted to all of the plurality of recovery blocks in which deadlocks have occurred, the deadlock manager block may determine that a system recovery attempt has failed.

As an embodiment, when the performing of the system recovery service routine by the CPU is not completed even after deadlock resolution commands are transmitted to all of a plurality of master blocks and all of a plurality of slave blocks in which deadlocks have occurred, the deadlock manager block may determine that the system recovery attempt has failed.

As an embodiment, when it is determined that the system recovery attempt has failed, the deadlock manager block may transmit a system reset command to a system reset block to reboot all blocks in a whole system to reset all the blocks.

As an embodiment, the recovery block may be a master recovery block operably connected to a particular master block among a plurality of master blocks. The master recovery block may be operably coupled to the particular master block through a command channel via which a command is received from the particular master block and a response channel via which a response is transmitted to the particular master block.

As an embodiment, the master recovery block may include: a first buffer interfaced with the command channel and a second buffer interfaced with the response channel; a virtual command generation module operably coupled to the first buffer to generate a deadlock occurrence signal; a virtual response reception module operably coupled to the second buffer to receive a command received from the system bus; and a deadlock clear control module operably coupled to the first buffer and the second buffer, and configured to receive first control commands associated with a deadlock resolution command from the deadlock manager block.

As an embodiment, the master recovery block may further include: a command monitor module operably coupled to the first buffer and the system bus, and configured to monitor control commands transmitted through the command channel; a response monitor module operably coupled to the second buffer and the system bus and configured to monitor responses transmitted through the response channel; and a deadlock detection module which is operably coupled to the command monitor module and the response monitor module, and detects a deadlock of the system and transmits a deadlock occurrence signal to the deadlock manager module.

As an embodiment, the recovery device may further include a slave recovery block operatively connected to a particular slave block among a plurality of slave blocks. The slave recovery block may be operably coupled to the system bus through a command channel via which a command is received from the system bus and a response channel via which a response is transmitted to the system bus.

As an embodiment, the slave recovery block may include: a third buffer interfaced with the command channel and a fourth buffer interfaced with the response channel, the third buffer and the fourth buffer being operably coupled to the particular slave block; a virtual command reception module operably coupled to the third buffer and configured to receive a control command associated with the deadlock occurrence signal; a virtual response generation module operably coupled to the fourth buffer and configured to generate a response associated with the deadlock occurrence signal; and a deadlock clear control module operably coupled to the third buffer and the fourth buffer, and configured to receive second control commands associated with a deadlock resolution command from the deadlock manager block.

As an embodiment, the slave recovery block may further include: a command monitor module operably coupled to the third buffer and the system bus, and configured to monitor control commands transmitted through the command channel; a response monitor module operably coupled to the fourth buffer and the system bus and configured to monitor responses transmitted through the response channel; and a deadlock detection module which is operably coupled to the command monitor module and the response monitor module, and detects a deadlock in the system to transmit a deadlock occurrence signal to the deadlock manager module.

As an embodiment, the deadlock manager module may include: a deadlock information module configured to receive a deadlock occurrence signal from the deadlock detection module of the master recovery block and receive a deadlock occurrence signal from the deadlock detection module of the slave recovery block; and a deadlock clear module configured to transmit control commands associated with the deadlock resolution command to the deadlock clear control module of the master recovery block and transmit second control commands associated with clearing of the deadlock to the deadlock clear control module of the slave recovery block.

According to another aspect of this specification, there is also provided a recovery method for resolving a system deadlock in a vehicle, the recovery method including: a deadlock monitoring process of, by a recovery block, monitoring occurrence of a deadlock in a system; a deadlock determination process of, by a deadlock manager block, receiving a signal of the deadlock occurrence from the recovery block and determining whether the deadlock has occurred in the system; a deadlock occurrence signal transmission process of, by the recovery block, generating and transmitting a deadlock occurrence signal when the deadlock in the system occurs; an interrupt transmission process of, by the deadlock manager block, transmitting an interrupt to a central processing unit (CPU), upon receiving the deadlock occurrence signal from the recovery block; a deadlock resolution command transmission process of, by the deadlock manager block, determining that the CPU is in a deadlock when an internal timer expires, and transmitting a deadlock resolution command to the recovery block; and a deadlock resolving process of, by the recovery block, resolving a deadlock of a corresponding interface associated with the deadlock resolution command upon receiving the deadlock resolution command, and controlling a corresponding function block associated with the deadlock resolution command to be isolated from the system bus.

As an embodiment, the recovery method may further include: after the interrupt transmission process, a deadlock resolution determination process of determining whether the deadlock of the recovery block has been resolved and the CPU is operable; and an interrupt clearing process of, by the CPU, performing a system recovery service routine and clearing an interrupt of the deadlock manager block when it is determined that the deadlock of the recovery block has been resolved and the CPU is operable.

As an embodiment, the corresponding function block may be a first recovery block operably connected to a first master block among a plurality of master blocks. In the deadlock resolution determination process, the deadlock manager block may determine that the CPU is still in a deadlock when the deadlock of the first recovery block has been resolved but the interrupt of the deadlock manager block is not cleared and the internal timer of the deadlock manager block expires again. A second deadlock resolution command may be transmitted to a second recovery block to which a second deadlock signal has been transmitted, and the internal timer may be controlled to re-operate. The second recovery block may be operably coupled to a second master block among the plurality of master blocks.

As an embodiment, in the deadlock resolution command transmission process, the deadlock manager block may repeatedly transmit a plurality of deadlock resolution commands to a plurality of recovery blocks until the CPU completes the performing of the system recovery service routine. In a deadlock resolution command transmission completion determination process, the deadlock manager block may determine that a system recovery attempt has failed when the plurality of deadlock resolution commands are transmitted to all of the plurality of recovery blocks in which deadlocks have occurred.

As an embodiment, after the deadlock occurrence signal transmission process, a deadlock occurrence information collection process of collecting information regarding occurrence locations in which the deadlocks have occurred and an order of the occurrence may be performed. After the interrupt transmission process, the recovery method may further include an internal timer expiration determination process of determining whether the internal timer has expired, by counting the internal timer of the deadlock manager block; and a deadlock resolution command transmission completion determination process of determining whether deadlock resolution commands have been transmitted to all the occurrence locations according to the order of the occurrence.

### Advantageous Effects of Invention

Hereinafter, technical effects of a recovery device and method which resolve a system deadlock are described.

According to this specification, a problem such that an entire scenario operation needs to be performed again because continuity with previous operations is lost due to initialization of a whole system may be solved.

According to this specification, when a system is initialized due to a deadlock, continuity with previous operations may be preserved at maximum.

According to this specification, an issue such that it is difficult to maintain continuity of operations due to a limited amount of preserved information caused by resource problems in storage spaces according to storage of intermediate states at particular intervals during performance of all operations may be resolved.

According to this specification, an issue such that an intermediate state storage process increases overhead of a central processing unit may be solved.

According to this specification, a central processing unit may be independently protected from being brought into a deadlock state so that the central processing unit may attempt a system recovery without having to reset a whole system.

According to this specification, a method of providing information to identify a cause of a deadlock may be proposed.

According to this specification, when system recovery may be executed through a central processing unit instead of using a method of initializing a whole system in the related art, continuity of operations may be preserved and a function loss section due to system initialization may be minimized.

Further scope of applicability of the disclosure will become apparent from the following detailed description. It should be understood, however, that the detailed description and specific examples, such as the preferred embodiment of the disclosure, are given by way of illustration only, since various changes and modifications within the spirit and scope of the disclosure will be apparent to those skilled in the art.

### BRIEF DESCRIPTION OF DRAWINGS

FIG. 1 illustrates an example of a communication system to which implementation of this specification is applied.

FIG. 2 illustrates an example of a wireless device to which implementation of this specification is applied.

FIG. 3 illustrates types of V2X applications.

FIG. 4 is a block diagram referenced for explaining a vehicle and a communication system mounted on the vehicle according to an embodiment of this specification.

FIG. 5 illustrates a configuration of a recovery device that resolves a deadlock in a communication system according to this specification.

FIG. 6 illustrates a structure diagram of an interface for exchanging a signal or a command between respective components according to occurrence of a deadlock in the recovery device of FIG. 5.

FIG. 7A and FIG. 7B illustrate an operational flowchart of a recovery method performed by the recovery device that resolves a system deadlock according to this specification.

FIG. 8 illustrates a detailed structure of master-side recovery blocks and a detailed block of a deadlock manager.

FIG. 9 illustrates a detailed structure of slave-side recovery blocks that interoperate with master-side recovery blocks through the deadlock manager of FIG. 8.

FIG. 10 illustrates a flowchart of a recovery method for resolving a system deadlock according to this specification.

FIG. 11 illustrates a configuration of a vehicle that interoperates with the recovery device according to this specification.

### MODE FOR THE INVENTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. Suffixes “module” and “unit” used for components used in the following description are merely intended for easy description of this specification, and each suffix itself is not intended to give any special meaning or function. In describing the embodiments disclosed herein, moreover, the detailed description will be omitted when a specific description for publicly known technologies to which the disclosure pertains is judged to obscure the gist of the disclosure. The accompanying drawings are used to help easily understand various technical features, and it should be understood that the embodiments presented herein are not limited by the accompanying drawings. As such, the disclosure should be construed to extend to any alterations, equivalents, and substitutes in addition to those which are particularly set forth in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element may be connected with the another element or intervening elements may also be present. In contrast, when an element is referred to as being “directly connected with” another element, there are no intervening elements present.

The singular forms are intended to include the plural forms as well, unless the context clearly indicates otherwise.

Terms “include” or “has” as used herein should be understood that they are intended to indicate the existence of a feature, a number, a step, an element, a component, or a combination thereof disclosed in this specification, and it may also be understood that the existence or additional possibility of one or more other features, numbers, steps, elements, components, or combinations thereof are not excluded in advance.

Hereinafter, a method for resolving a deadlock in a communication system according to this specification and a device that performs the method are described. In this regard, the communication system may be a communication system for performing communication in a vehicle, but is not limited thereto.

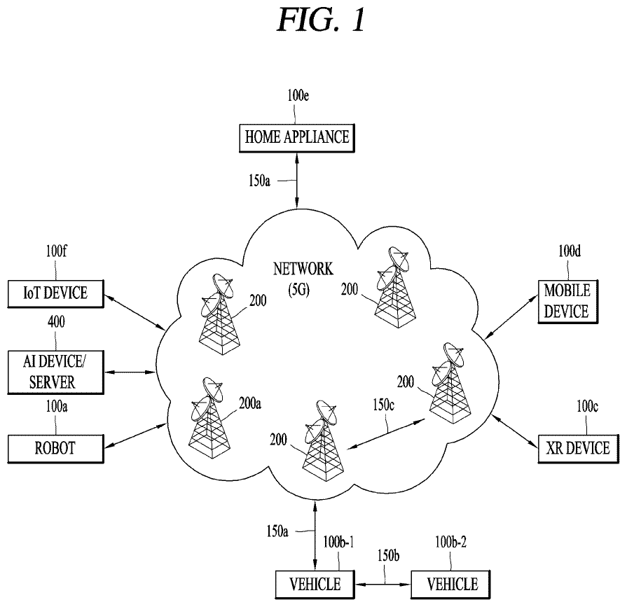

FIG. 1 illustrates an example of a communication system to which implementation of this specification is applied. A fifth-generation (5G) usage scenario shown in FIG. 1 corresponds to one example, and the implementation is not limited thereto. 5G technology is a means for providing streams rated at hundreds of megabits per second in gigabits per second to compensate for a fiber-to-the-home (FTTH) and a cable-based broadband (or a data over cable service interface specification (DOCSIS)). Such a high speed is needed to deliver TV images with resolutions of 4K or higher (6K, 8K, or higher), as well as virtual reality and augmented reality. Virtual reality (VR) and augmented reality (AR) applications include immersive sports games. Particular applications may need a special network configuration. For example, in a case of an VR game, a game company needs to integrate a core server with an edge network server of a network operator to minimize latency.

An automotive is expected to be a significant new driving force for 5G technology, together with many use cases for mobile communications for vehicles. For example, entertainment for passengers requires high concurrency and broadband mobile communications with high mobility. This is because future users would continue to expect high-quality connections regardless of locations and speeds. Another use case in an automotive field is an AR dashboard. The AR dashboard enables a driver to identify an object in a dark place in addition to objects visible through a windshield, and overlaps information provided to the driver to indicate a distance to objects and movement of the objects. In the future, a wireless module may enable communication between vehicles, information exchange between a vehicle and supporting infrastructure, and information exchange between a vehicle and other connected devices (e.g., devices accompanied by pedestrians). A safety system may reduce a risk of an accident by guiding substitute courses of action to a driver so that the driver may drive more safely. A next step will be a remotely controlled or autonomously traveling vehicle. This requires extremely high reliability and very fast communication between different autonomous vehicles, and between vehicles and infrastructure. In the future, autonomous vehicles will perform all travel tasks and drivers will focus solely on traffic that a vehicle cannot identify. The technological requirements for autonomous vehicles demand ultra-low latency and ultra-high reliability to increase traffic safety to a level that humans cannot achieve.

Referring to FIG. 1, a communication system 1 includes wireless devices 100a to 100f, base stations (BSs) 200, and a network 300. Although FIG. 1 illustrates a 5G network as an example of a network of the communication system 1, an implementation of this specification is not limited to a 5G system and may be applied to future communication systems beyond the 5G system.

The base stations 200 and the network 300 may be implemented as wireless devices, and a particular wireless device may operate as a base station/network node with respect to other wireless devices.

The wireless devices 100a to 100f refer to devices that perform communication using a radio access technology (RAT) (e.g., 5G NR or LTE), and may also be referred to as communication/wireless/5G devices. The wireless devices 100a to 100f are not limited thereto, and may include a robot 100a, vehicles 100b-1 and 100b-2, an extended reality (XR) device 100c, a mobile device 100d, a home appliance 100e, an internet-of-things (IOT) device 100f, and an artificial intelligence (AI) device/server 400. For example, the vehicles may include a vehicle with wireless communication functions, an autonomous vehicle, or a vehicle capable of performing communications between vehicles. The vehicles may include an unmanned aerial vehicle (UAV) (e.g., a drone). The XR device may include augmented reality (AR)/virtual reality (VR)/mixed reality (MR) devices, and may be implemented in a form of a head-mounted device (HMD) or a head-up display (HUD) mounted on a vehicle, a television, a smartphone, a computer, a wearable device, a home appliance, digital signage, a vehicle, a robot, or the like. The mobile device may include a smartphone, a smart pad, a wearable device (e.g., a smart watch or smart glasses), and a computer (e.g., a laptop computer). The home appliance may include a TV, a refrigerator, or a washing machine. The IoT device may include a sensor or a smart meter.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g.: LTE) network, a 5G (e.g.: NR) network, and a network after 5G. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., V2V/V2X communication). The IoT device (e.g., a sensor) may perform direct communication with other IoT devices (e.g.: sensors) or other wireless devices 100a to 100f.

Wireless communications/connections 150a, 150b, and 150c may be established between the wireless devices 100a to 100f and/or between the wireless devices 100a to 100f and the BSs 200 and/or between the BSs 200. Here, wireless communications/connections may be established via various RATs (e.g., 5G NR), such as uplink/downlink communication 150a, sidelink communication 150b (or, device-to-device (D2D)) communication), base station-to-base station communication 150c (e.g., relay, integrated access and backhaul n(IAB)), etc. Through the wireless communications/connections 150a, 150b, and 150c, the wireless devices 100a to 100f and the BSs 200 may transmit/receive radio signals to each other. For example, the wireless communications/connections 150a, 150b, and 150c may transmit/receive signals through various physical channels. To this end, based on various proposals of the disclosure, at least some of various configuration information setting processes for transmitting/receiving radio signals, various signal processing processes (e.g.: channel encoding/decoding, modulation/demodulation, resource mapping/demapping, and the like), or a resource allocation process may be performed.

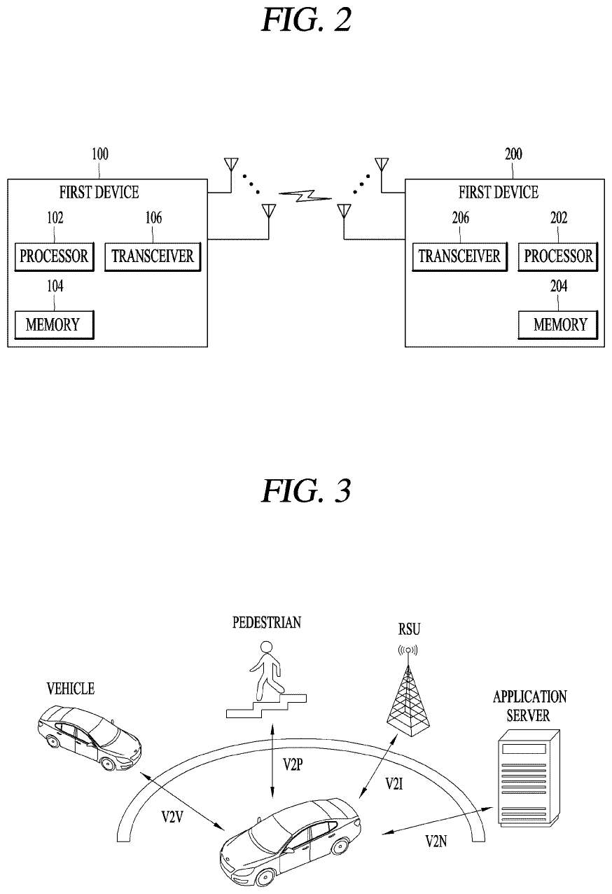

FIG. 2 is a view of an example of wireless devices to which implementation of this specification is applied. Referring to FIG. 2, a first wireless device 100 and a second wireless device 200 may transmit and receive radio signals through a variety of radio access technologies (e.g.: LTE and NR). In FIG. 2, {the first wireless device 100 and the second wireless device 200} may correspond to at least one of {the wireless devices 100a to 100f and the base station 200}, {the wireless devices 100a to 100f and the wireless devices 100a to 100f}, and/or {the base station 200 and the base station 200} of FIG. 1.

The first wireless device 100 may include at least one processor 102 and at least one memory 104. The first wireless device 100 may further include at least one transceiver 106 and/or at least one antenna 108. The processor 102 may control the memory 104 and/or the transceiver 106. The processor 102 may be configured to implement the descriptions, functions, procedures, suggestions, methods and/or operational flowcharts disclosed herein. For example, the processor 102 may process information inside the memory 104 to generate first information/signals and then transmit radio signals including the first information/signals through the transceiver 106. The processor 102 may receive radio signals including second information/signals through the transceiver 106 and then store information obtained by processing the second information/signals in the memory 104. The memory 104 may be connected to the processor 102 and may store a variety of information related to the operation of the processor 102. For example, the memory 104 may store software codes including commands for performing some or all of processes controlled by the processor 102 or for performing the descriptions, functions, procedures, suggestions, methods and/or operational flowcharts disclosed herein. Herein, the processor 102 and the memory 104 may be a part of a communication modem/circuit/chip designed to implement RAT (e.g.: LTE and NR). The transceiver 106 may be connected to the processor 102 and transmit and/or receive radio signals through at least one antenna 108. The transceiver 106 may include a transmitter and/or a receiver. The transceiver 106 may be interchangeably used with a radio frequency (RF) unit. In the disclosure, the first wireless device 100 may also refer to a communication modem/circuit/chip.

The second wireless device 200 may include at least one processor 202 and at least one memory 204. The second wireless device 200 may further include at least one transceiver 206 and/or at least one antenna 208. The processor 202 may control the memory 204 and/or the transceiver 206. The processor 202 may be configured to implement the descriptions, functions, procedures, suggestions, methods and/or operational flowcharts disclosed herein. For example, the processor 202 may process information inside the memory 204 to generate third information/signals and then transmit radio signals including the third information/signals through the transceiver 206. The processor 202 may receive radio signals including fourth information/signals through the transceiver 206 and then store information obtained by processing the fourth information/signals in the memory 204. The memory 204 may be connected to the processor 202 and may store a variety of information related to the operation of the processor 202. For example, the memory 204 may store software codes including commands for performing some or all of processes controlled by the processor 202 or for performing the descriptions, functions, procedures, suggestions, methods and/or operational flowcharts disclosed herein. Herein, the processor 202 and the memory 204 may be a part of a communication modem/circuit/chip designed to implement RAT (e.g.: LTE and NR). The transceiver 206 may be connected to the processor 202 and transmit and/or receive radio signals through at least one antenna 208. The transceiver 206 may include a transmitter and/or a receiver. The transceiver 206 may be interchangeably used with a radio frequency (RF) unit. In the disclosure, the second wireless device 200 may also refer to a communication modem/circuit/chip.

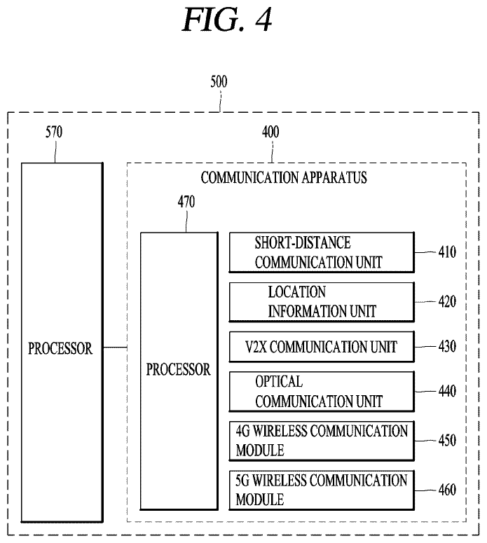

The vehicle may be configured to communicate with pedestrians, adjacent infrastructures, and/or servers in addition to adjacent vehicles. In this regard, FIG. 3 illustrates types of V2X applications. Referring to FIG. 2, vehicle-to-everything (V2X) communication may include communication between a vehicle and each of all entities, such as vehicle-to-vehicle (V2V) communication which refers to communication between vehicles, vehicle-to-infrastructure (V2I) communication which refers to communication between a vehicle and an eNB or a road side unit (RSU), vehicle-to-pedestrian (V2P) communication which refers to communication between a vehicle and a terminal carried by a person (a pedestrian, a cyclist, a vehicle driver, or a passenger), vehicle-to-network (V2N) communication, and the like.

In order to support the V2X communication, the vehicle may perform wireless communication with eNB and/or gNB through an antenna system. In this regard, the antenna module may be implemented as an external antenna module and/or an internal antenna module as illustrated in FIGS. 1A to 1C.

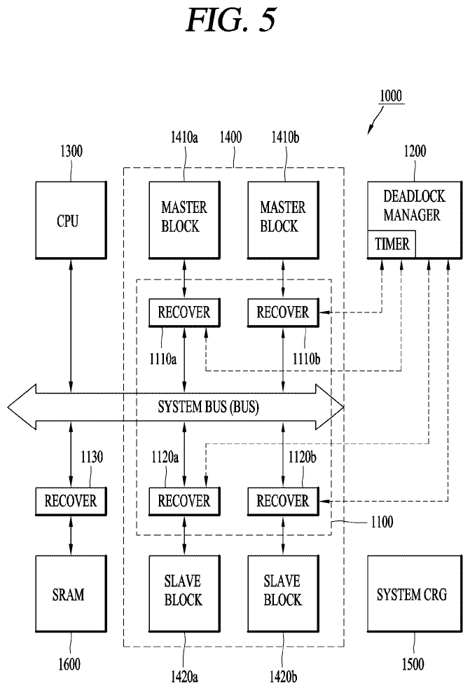

In some embodiments, FIG. 4 is a block diagram illustrating a vehicle and a communication system mounted on the vehicle according to an embodiment.

The vehicle 500 may include a communication device 400 and a processor 570. The communication device 400 may correspond to the telematics control unit (TCU) of the vehicle 500.

The communication device 400 may be a device for performing communication with an external device. Here, the external device may be another vehicle, a mobile terminal, or a server. The communication device 400 may perform the communication by including at least one of a transmitting antenna, a receiving antenna, and radio frequency (RF) circuit and RF device for implementing various communication protocols. In this regard, the communication device 400 may include a short-range communication unit 410, a location information unit 420, a V2X communication unit 430, an optical communication unit 440, a 4G wireless communication module 450, and a 5G wireless communication module 460. The communication device 400 may include a processor 470. According to an embodiment, the communication device 400 may further include other components in addition to the components described, or may not include some of the components described.

The 4G wireless communication module 450 and the 5G wireless communication module 460 may perform wireless communications with one or more communication systems through one or more antenna modules. The 4G wireless communication module 450 may transmit and/or receive signals to and/or from a device in a first communication system through a first antenna module. Also, the 5G wireless communication module 460 may transmit and/or receive signals to and/or from a device in a second communication system through a second antenna module. The 4G wireless communication module 450 and 5G wireless communication module 460 may also be physically implemented as one integrated communication module. For example, the first communication system and the second communication system may be an LTE communication system and a 5G communication system, respectively. However, the first communication system and the second communication system may not be limited thereto, and may expand to any different communication systems.

The processor of the device within the vehicle 500 may be implemented as a micro control unit (MCU) or a modem. The processor 470 of the communication device 400 may correspond to a modem, and the processor 470 may be implemented as an integrated modem. The processor 470 may acquire surrounding information from other adjacent vehicles, objects, or infrastructures through wireless communication. The processor 470 may perform vehicle control using the acquired surrounding information.

The processor 570 of the vehicle 500 may be a processor of a car area network (CAN) or advanced driving assistance system (ADAS), but is not limited thereto. When the vehicle 500 is implemented in a distributed control manner, the processor 570 of the vehicle 500 may be replaced with a processor of each device.

In some examples, the antenna module arranged in the vehicle 500 may include a wireless communication unit. The 4G wireless communication module 450 may perform transmission and reception of 4G signals with a 4G base station through a 4G mobile communication network. In this instance, the 4G wireless communication module 450 may transmit at least one 4G transmission signal to the 4G base station. In addition, the 4G wireless communication module 450 may receive at least one 4G reception signal from the 4G base station. In this regard, uplink (UL) multi-input/multi-output (MIMO) may be performed based on a plurality of 4G transmission signals transmitted to the 4G base station. In addition, downlink (DL) MIMO may be performed based on a plurality of 4G reception signals received from the 4G base station.

The 5G wireless communication module 460 may perform transmission and reception of 5G signals with a 5G base station through a 5G wireless communication network. Here, the 4G base station and the 5G base station may have a non-stand-alone (NSA) architecture. The 4G base station and the 5G base station may be arranged, for example, in the non-stand-alone (NSA) architecture. Alternatively, the 5G base station may be arranged in a stand-alone (SA) architecture at a separate location from the 4G base station. The 5G wireless communication module 460 may perform transmission and reception of 5G signals with a 5G base station through a 5G wireless communication network. In this instance, the 5G wireless communication module 460 may transmit at least one 5G transmission signal to the 5G base station. In addition, the 5G wireless communication module 460 may receive at least one 5G reception signal from the 5G base station. In this instance, a 5G frequency band that is the same as a 4G frequency band may be used, and this may be referred to as LTE re-farming. In some examples, a Sub6 frequency band, which is a range of 6 GHz or less, may be used as the 5G frequency band. In contrast, a millimeter-wave (mmWave) band may be used as the 5G frequency band to perform wideband high-speed communication. When the mmWave band is used, the electronic device may perform beamforming for coverage expansion of an area where communication with a base station is possible.

Regardless of the 5G frequency band, in the 5G communication system, MIMO may be supported to be performed a plurality of times, to improve a transmission rate. In this instance, UL MIMO may be performed by a plurality of 5G transmission signals that are transmitted to a 5G base station. DL MIMO may be performed by a plurality of 5G reception signals that are received from the 5G base station.

In some examples, a state of dual connectivity (DC) with both the 4G base station and the 5G base station may be attained through the 4G wireless communication module 450 and the 5G wireless communication module 460. As such, the dual connectivity with the 4G base station and the 5G base station may be referred to as EUTRAN NR DC (EN-DC). In some examples, when the 4G base station and the 5G base station are arranged in a co-located structure, throughput improvement may be achieved by inter-carrier aggregation (inter-CA). Accordingly, when the 4G base station and the 5G base station are arranged in the EN-DC state, the 4G reception signal and the 5G reception signal may be simultaneously received through the 4G wireless communication module 450 and the 5G wireless communication module 460. Short-range communication between electronic devices (e.g., vehicles) may be performed between electronic devices (e.g., vehicles) using the 4G wireless communication module 450 and the 5G wireless communication module 460. In one embodiment, after resources are allocated, vehicles may perform wireless communication in a V2V manner without a base station.

In some embodiments, for transmission rate improvement and communication system convergence, carrier aggregation (CA) may be carried out using at least one of the 4G wireless communication module 450 and the 5G wireless communication module 460 and a WiFi communication module 113. In this regard, 4G+WiFi carrier aggregation (CA) may be performed using the 4G wireless communication module 450 and the WiFi communication module 113. Or, 5G+WiFi CA may be performed using the 5G wireless communication module 460 and the WiFi communication module.

In some examples, the communication device 400 may implement a display device for a vehicle together with a user interface device. In this instance, the display device for the vehicle may be referred to as a telematics apparatus or an audio video navigation (AVN) apparatus.

Hereinafter, a method for resolving a deadlock in a communication system according to this specification and a device that performs the method are described. In this regard, the communication system may be a communication system for performing communication in a vehicle, but is not limited thereto.

In this regard, when a deadlock in a system occurs, a method of checking a system deadlock through a watchdog and initializing an operation by rebooting through resetting of a whole system may be implemented. However, the method of initializing by rebooting through resetting of a whole system may generally cause a significant loss of functionality in terms of system operation. For example, when a system deadlock occurs due to a problem in a small functional block which is not significantly related to a main system operation, initialization of a whole system may cause a significant increase in sections in which functions are lost.

Therefore, a recovery device and method for resolving a system deadlock according to this specification need to be implemented to achieve technical effects described below. Through an embodiment according to this specification, a problem such that an entire scenario operation needs to be performed again because continuity with previous operations is lost due to initialization of a whole system needs to be solved. Through an embodiment according to this specification, when a system is initialized due to a deadlock, continuity with previous operations needs to be preserved at maximum. Through an embodiment according to this specification, an issue such that it is difficult to maintain continuity of operations due to a limited amount of preserved information caused by resource problems in storage spaces according to storage of intermediate states at particular intervals during performance of all operations may be resolved. Through an embodiment according to this specification, an issue such that an intermediate state storage process increases overhead of a central processing unit needs to be solved. Through an embodiment according to this specification, a central processing unit needs to be independently protected from being brought into a deadlock state so that the central processing unit may attempt system recovery without having to reset the whole system. Through an embodiment according to this specification, a method of providing information to identify a cause of a deadlock needs to be proposed. Through an embodiment according to this specification, continuity of operations needs to be preserved and a function loss section due to system initialization needs to be minimized when system recovery may be executed through a central processing unit instead of using a method of initializing a whole system.

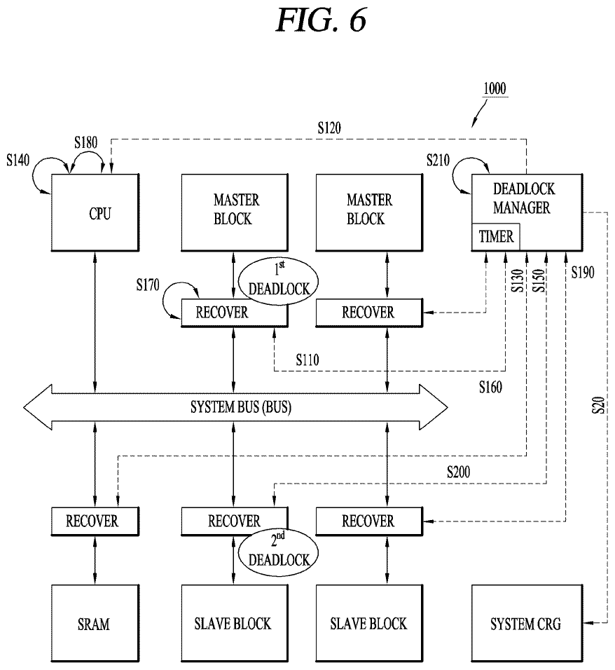

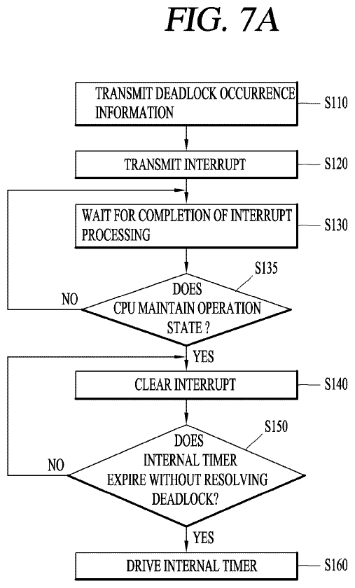

In this regard, FIG. 5 illustrates a configuration of a recovery device that resolves a deadlock in a communication system according to this specification. Meanwhile, FIG. 6 illustrates a structure diagram of an interface for exchanging a signal or a command between respective components according to occurrence of a deadlock in the recovery device of FIG. 5. The recovery device shown in FIGS. 5 and 6 may be a first device 100 having the processor 102 and the memory 104 or a second device 200 having the processor 202 and the memory 204 each shown in FIG. 2. The first device 100 or the second device 200 may interoperate with other devices by transmitting or receiving signals and commands to or from other devices via the transceiver 106 or 206 operably coupled to the processor 102 or 202.

In this regard, respective components of FIGS. 5 and 6 may correspond to a hardware block or a chip mounted on a main board, but are not limited thereto, and some of the respective components may be software blocks or some components in another chip.

Referring to FIGS. 5 and 6, a recovery device 1000 configured to resolve a system deadlock in a vehicle may be configured to include a recovery block 1100, a deadlock manager block 1200, and a central processing unit (CPU) 1300.

In this regard, hereinafter, operational characteristics of each of the aforementioned functional blocks and CPU are described. The recovery block 1100 may be included for each interface connected to other functional blocks and a system bus other than the central processing unit (CPU) 1300. The recovery block 1100 monitors commands and responses in communication between other functional blocks and the system bus, and when a deadlock occurs, transmits occurrence information to the deadlock manager block 1200. When the deadlock manager block 1200 transmits a deadlock resolution command, the deadlock between the corresponding function blocks and the system bus may be resolved.

After the deadlock is resolved, the functional blocks need to be controlled to be isolated from the system bus.

The deadlock manager block 1200 collects deadlock information transmitted from the whole recovery block 1100. The deadlock manager block 1200 may be configured to manage order information of deadlocks that have occurred in and are transmitted from the recovery block 1100. When the deadlock information is transmitted from the recovery block 1100, the deadlock manager block 1200 transmits the information to the central processing unit (CPU) 1300 through an interrupt. The deadlock manager block 1200 has an internal timer arranged therein and waits for the CPU 1300 to process the interrupt within particular time.

When the interrupt is not processed by the CPU 1300 until the internal time is completed, it is determined that the CPU 1300 is brought into a deadlock state and the deadlock manager block 1200 may perform deadlock resolution based on stored deadlock information. In this regard, the deadlock manager block 1200 transmits a deadlock resolution command to the recovery block 1100 according to a policy established based on the stored deadlock information. When an attempt for deadlock according to the established policy fails, rebooting may be performed through resetting of a whole system.

When an interrupt occurs in the deadlock manager block 1200, the central processing unit (CPU) 1300 performs a predefined system recovery service routine. A system recovery program may be stored in an inner space of a separate SRAM 1600. The system recovery program stored in the inner space of the SRAM 1600 may be managed to be maintained even when resetting is authorized for system recovery. The SRAM 1600 may also be operably coupled to a system bus BUS via a recovery block 1130.

In relation to the operational characteristics described above, the recovery device 1000 for resolving a system deadlock claimed in this specification is described in detail. The recovery block 1100 may be configured to generate and transmit a deadlock occurrence signal when a deadlock occurs in a system. The recovery block 1100 may transmit a deadlock occurrence signal to the deadlock manager block 1200. Additionally, the recovery block 1100 may transmit a deadlock occurrence signal to an operation block 1400 which is a master block or a slave block connected to the recovery block 1100. The operation block 1400 may be a hardware block or a chip that performs a particular operation of a vehicle and controlling of the same.

The operation block 1400 may be configured to include master blocks 1410a and 1410b and slave blocks 1420a and 1420b. The master blocks 1410a and 1410b may be operably coupled to recovery blocks 1110a and 1110b, respectively. The slave blocks 1420a and 1420b may be operably coupled to recovery blocks 1120a and 1120b, respectively. Each of the master blocks 1410a and 1410b and the slave blocks 1420a and 1420b may be configured as a chip equipped with an intellectual property (IP) block that perform a particular operation or function and a processor.

The central processing unit (CPU) 1300 may be operably coupled to the system bus BUS. The CPU 1300 may be configured to receive an interrupt from the deadlock manager block 1200 and clear the interrupt in an operating state. The deadlock manager block 1200 may determine that the CPU 1300 is in a deadlock state when the internal timer expires. The deadlock manager block 1200 may transmit a deadlock resolution command to the recovery block 1100 and control the internal timer to reoperate.

When the deadlock resolution command is received, the recovery block 1100 may interoperate with the deadlock manager block 1200 to control to resolve a deadlock of a corresponding interface associated with the deadlock resolution command. In this regard, a corresponding function block associated with the deadlock resolution command may be controlled to be isolated from the system bus BUS.

The recovery block 1100 may control signals and commands transmitted from a particular operation block associated with the deadlock resolution command not to be transmitted to the system bus BUS. In this regard, the recovery block 1100 may control signals and commands transmitted from a particular operation block not to be delivered to the system bus BUS until before the deadlock is completely resolved. The recovery block 1100 may interoperate with the deadlock manager block 1200 to deliver response signals with respect to signals and commands transmitted from a particular operation block to the particular operation block. However, the recovery block 1100 may interoperate with the deadlock manager block 1200 to configure a port so that received signals and commands are not transmitted to other blocks through the system bus BUS.

A deadlock may be detected in one of a plurality of master blocks or slave blocks. When a deadlock occurs in the first master block 1410a, a corresponding function block associated with a deadlock resolution command may be the first master block 1410a among the plurality of master blocks. Alternatively, a corresponding functional block associated with the deadlock resolution command may be a first recovery block 1110a operably connected to a master block 1400a.

When a deadlock in the first recovery block 1110a and/or the first master block 1410a is resolved and it is determined that the CPU 1300 is operable, the CPU 1300 may perform a system recovery service routine. Accordingly, when a system deadlock is resolved and it is determined that the CPU 1300 is operable, an interrupt of the deadlock manager block 1200 may be cleared. In this regard, when it is determined that one of a plurality of deadlocks has been resolved, the CPU 1300 may clear only the interrupt of the deadlock manager block 1200 corresponding to the resolved deadlock.

Even when a deadlock in a particular block is resolved, the CPU 1300 may be still maintained in the deadlock state. In this regard, although the deadlock of the first recovery block 1110a is resolved, the interrupt of the deadlock manager block 1200 may not be cleared and the internal timer of the deadlock manager block 1200 may expire again. When the interrupt of the deadlock manager block 1200 is not cleared and the internal timer expires again, the deadlock manager block 1200 may determine that the CPU 1300 is still in the deadlock state.

The deadlock manager block 1200 may transmit a second deadlock resolution command to the second recovery block 1110b to which a second deadlock signal has been transmitted, and control the internal timer to reoperate. The second recovery block 1110b may be operably coupled to the second master block 1410b among the plurality of master blocks.

Meanwhile, although deadlock resolution commands have been sent to all recovery blocks, when a deadlock still remains, it may be determined that a system recovery has failed. Until the CPU completes the performing of a system recovery service routine, the deadlock manager block 1200 may repeatedly transmit a plurality of deadlock resolution commands to a plurality of recovery blocks 1100. When a plurality of deadlock resolution commands are transmitted to all of the plurality of recovery blocks 1110a, 1110b, 1120a and 1120b in which deadlocks have occurred, the deadlock manager block 1200 may determine that a system recovery attempt has failed.

It may be determined that the system recovery attempt has failed after a plurality of resolution commands have been sent to all of the master blocks and the slave blocks. In this regard, the deadlock manager block 1200 may determine whether the performing of the system recovery service routine by the CPU 1300 has not been completed even after the deadlock resolution commands have been transmitted to all of the plurality of master blocks and all of the plurality of slave blocks in which deadlocks have occurred. When the performing of the system recovery service routine by the CPU 1300 is not completed even after the deadlock resolution commands have been transmitted, the deadlock manager block 1200 may determine that a system recovery attempt has failed.

When it is determined that the system recovery attempt has failed, rebooting may be performed by resetting a whole system. In this regard, when it is determined that the system recovery attempt has failed, the deadlock manager block 1200 may transmit a system reset command to a system reset block 1500. Accordingly, the deadlock manager block 1200 may reset all blocks of the whole system through rebooting all the blocks by interoperating with the system reset block 1500.

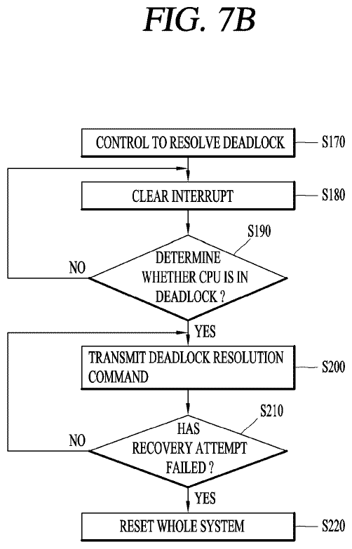

With regard to operation characteristics of each of the above-described components, an operation sequence between the respective components is described below in detail with reference to FIGS. 6 to 7B. FIG. 7A and FIG. 7B illustrate an operational flowchart of a recovery method performed by the recovery device that resolves a system deadlock according to this specification.

Referring to FIG. 7A, a recovery method performed by the recovery device that resolves a system deadlock may include a deadlock occurrence information transmission process (S110), an interrupt transmission process (S120), an interrupt processing completion standby process (S130), and a an interrupt clearing process (S140). The recovery method may further include a CPU operation state determination process (S135), an internal timer expiration determination process (S150), and an internal timer driving process (S160).

Referring to FIG. 7B, the recovery method may further include a deadlock resolution control method (S170), an interrupt clearing process (S180), a CPU deadlock determination process (S190), and a deadlock resolution command transmission process (S200). The recovery method may further include a recovery attempt failure determination process (S210) and a whole system resetting process (S220).

Referring to FIGS. 5 to 7B, when a deadlock occurs in the recovery block 1110a, occurrence information may be transmitted to the deadlock manager block 1200 (S110). When a deadlock occurrence signal is received from the recovery block 1110a, the deadlock manager block 1200 may transmit an interrupt to the CPU 1300 (S120). The deadlock manager block 1200 may drive an internal timer to wait for the CPU 1300 to complete processing within particular time (S130). When the CPU 1300 maintains an operation state in the CPU operation state determination process (S135), a system recovery service routine may be performed and the interrupt of the deadlock manager block 1200 may be cleared (S140).

When the CPU 1300 is brought into a deadlock state, the interrupt of the deadlock manager block 1200 may not be cleared and the internal timer of the deadlock manager block 1200 may expire (S150). The deadlock manager block 1200 may determine that the CPU is in a deadlock state when the internal timer expires, transmit a deadlock resolution command to the recovery block 1110a to which a first deadlock signal was transmitted, and then, drive the internal timer again (S160).

The recovery block 1110a may resolve a deadlock of a corresponding interface, and control a corresponding function block to be isolated from the system bus BUS (S170). When the CPU 1300 is capable of operating due to the resolving of the deadlock by the recovery block 1110a, a system recovery service routine may be performed and the interrupt of the deadlock manager block 1200 may be cleared (S180).

When the deadlock of the CPU 1300 is maintained even after the deadlock of the recovery block 1110a is resolved, the interrupt of the deadlock manager block 1200 may not be cleared yet and the internal timer of the deadlock manager block 1200 may expire again (S190). The deadlock manager block 1200 determines that the CPU 1300 is still in a deadlock state when the internal timer expires. Accordingly, a deadlock resolution command may be transmitted to the recovery block 1120a to which a next deadlock signal has been transmitted, and the internal timer may be driven again (S200).

The process of operations S170 to S200 may be repeated until the CPU 1300 performs the system recovery service routine. Accordingly, when a deadlock resolution command is transmitted to all recovery blocks in which deadlock signals have occurred, it may be determined that the system recovery attempt has failed (S210). When it is determined that the system recovery attempt has failed, rebooting may be performed by resetting the whole system through the system reset block 1500 (S220).

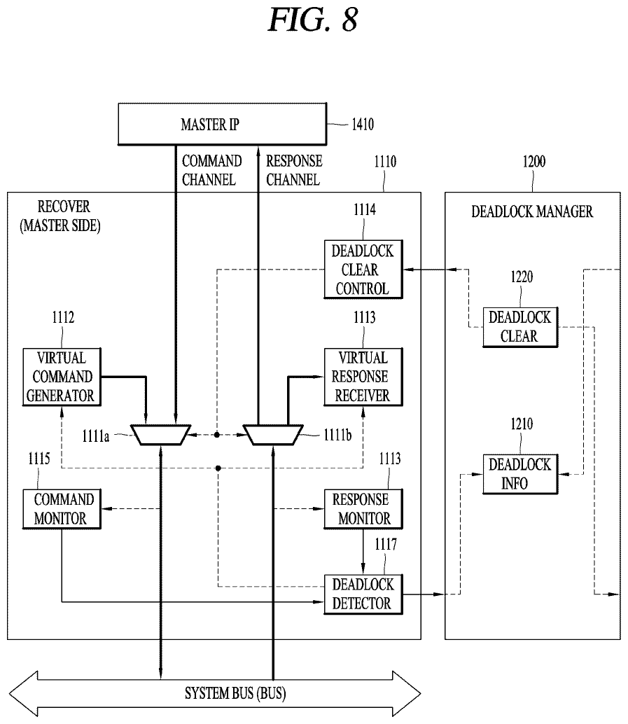

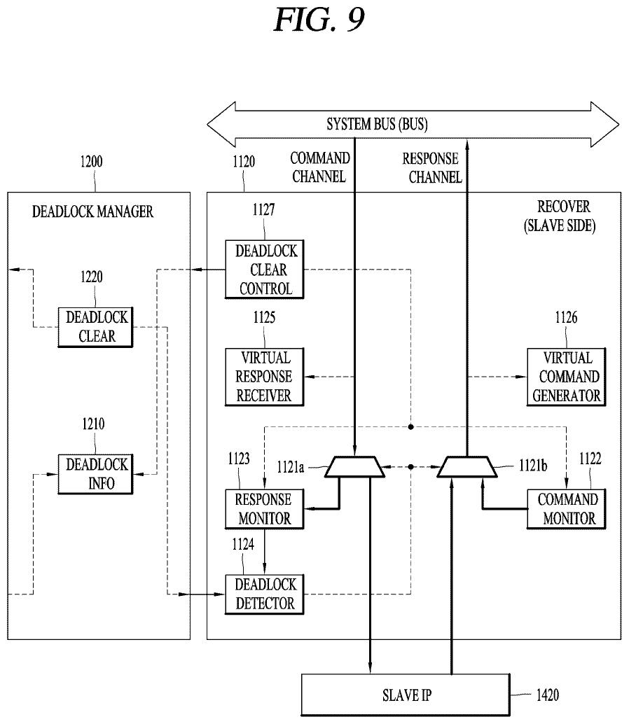

Hereinafter, a detailed structure of recovery blocks and deadlock manager blocks in the recovery device that resolves a deadlock in a communication system according to this specification is described. In this regard, FIG. 8 illustrates a detailed structure of master-side recovery blocks and a detailed block of a deadlock manager. Meanwhile, FIG. 9 illustrates a detailed structure of slave-side recovery blocks that interoperate with the master-side recovery blocks through the deadlock manager of FIG. 8.

Referring to FIGS. 8 and 9, an embodiment in which the master-side recovery blocks and the slave-side recovery blocks interoperate with each other through the deadlock manager block is shown, but the present disclosure is not limited thereto. Referring to FIGS. 5 to 9, the master side recovery blocks may interoperate with each other through the deadlock manager block. Alternatively, the slave-side recovery blocks may interoperate with each other via the deadlock manager block. Alternatively, one of the master-side recovery blocks may interoperate with a CPU via the manager block. Alternatively, one of the slave-side recovery blocks may interoperate with a CPU via the manager block.

Referring to FIGS. 5 to 9, a recovery block may be a master recovery block operably connected to a particular master block among the plurality of master blocks. A master recovery block 1110 may be operably coupled to a particular master block 1410 via a command channel and a response channel. The command channel may be configured to receive a command from the particular master block 1410. The response channel may be configured to transmit a response to the particular master block 1410.

The master recovery block 1110 may include a first buffer 1111a interfaced with the command channel and a second buffer 1111b interfaced with the response channel. The master recovery block 1110 may be configured to include a virtual command generation module 1112, a virtual response reception module 1113, and a deadlock clear control module 1114. The virtual command generation module 1112 may be configured to be operably coupled to the first buffer 1111a to generate a deadlock occurrence signal. The virtual response reception module 1113 may be configured to be operably coupled to the second buffer 1111b to receive a command received from the system bus BUS. The deadlock clear control module 1114 may be operably coupled to the first buffer 1111a and the second buffer 1111b. The deadlock clear control module 1114 may be configured to receive first control commands associated with a deadlock resolution command from the deadlock manager block 1200.

The master recovery block 1110 may be configured to further include a command monitor module 1115, a response monitor module 1116, and a deadlock detection module 1117. The command monitor module 1115 may be operably coupled to the first buffer 1111a and the system bus BUS. The command monitor module 1115 may be configured to monitor control commands transmitted through the command channel. The response monitor module 1116 may be operably coupled to the second buffer 1111b and the system bus BUS. The response monitor module 1116 may be configured to monitor responses transmitted through the response channel. The deadlock detection module 1117 may be operably coupled to the command monitor module 1115 and the response monitor module 1116. The deadlock detection module 1117 may be configured to detect a deadlock in the system and transmit a deadlock occurrence signal to the deadlock manager module 1200. The deadlock detection module 1117 may transmit the deadlock occurrence signal to a deadlock information module 1210 of the deadlock manager module 1200.

Referring to FIGS. 5 to 9, a recovery block may be a slave recovery block operably connected to a particular slave block among the plurality of master blocks. A slave recovery block 1120 may be operably coupled to the system bus BUS via a command channel and a response channel. The command channel may be configured to receive a command from the system bus BUS. The response channel may be configured to transmit a response to the system bus BUS.

The slave recovery block 1120 may include a third buffer 1121a interfaced with the command channel and a fourth buffer 1121b interfaced with the response channel. The third buffer 1121a and the fourth buffer 1121b may be operably coupled to a particular slave block 1420. The slave recovery block 1120 may be configured to include a virtual command reception module 1122, a virtual response generation module 1123, and a deadlock clear control module 1124. The virtual command generation module 1122 may be configured to be operably coupled to the third buffer 1121a to receive a control command associated with a deadlock occurrence signal. The virtual response generation module 1123 may be operably coupled to the fourth buffer 1121b and configured to generate a response associated with a deadlock occurrence signal. The deadlock clear control module 1124 may be operably coupled to the third buffer 1121a and the fourth buffer 1121b. The deadlock clear control module 1124 may be configured to receive second control commands associated with a deadlock resolution command from the deadlock manager block 1200.

The slave recovery block 1120 may be configured to further include a command monitor module 1125, a response monitor module 1126, and a deadlock detection module 1127. The command monitor module 1125 may be operably coupled to the third buffer 1121a and the system bus BUS. The command monitor module 1125 may be configured to monitor control commands transmitted through the command channel. The response monitor module 1126 may be operably coupled to the fourth buffer 1121b and the system bus BUS. The response monitor module 1126 may be configured to monitor responses transmitted through the response channel. The deadlock detection module 1127 may be operably coupled to the command monitor module 1125 and the response monitor module 1126. The deadlock detection module 1127 may be configured to detect a deadlock in the system and transmit a deadlock occurrence signal to the deadlock manager module 1200. The deadlock detection module 1117 may transmit a deadlock occurrence signal to the deadlock information module 1210 of the deadlock manager module 1200.

Referring to FIGS. 5 to 8, the deadlock manager module 1200 may be configured to include the deadlock information module 1210 and the deadlock clear control module 1220. The deadlock information module 1210 may be configured to receive a deadlock occurrence signal from the deadlock detection module 1117 of the master recovery block 1110. The deadlock information module 1210 may be configured to receive a deadlock occurrence signal from the deadlock detection module 1127 of the slave recovery block 1120.

The deadlock clear control module 1220 may be configured to transmit control commands associated with deadlock resolution commands to the deadlock clear control module 1114 of the master recovery block 1110. The deadlock clear control module 1220 may be configured to transmit second control commands associated with deadlock clearing to the deadlock clear control module 1124 of the slave recovery block 1120.

An operation of resolving a system deadlock according to an aspect of this specification and a recovery device that performs the operation have been described above. Hereinafter, an operation of resolving a system deadlock according to another aspect of this specification and a recovery method of performing the operation are described.

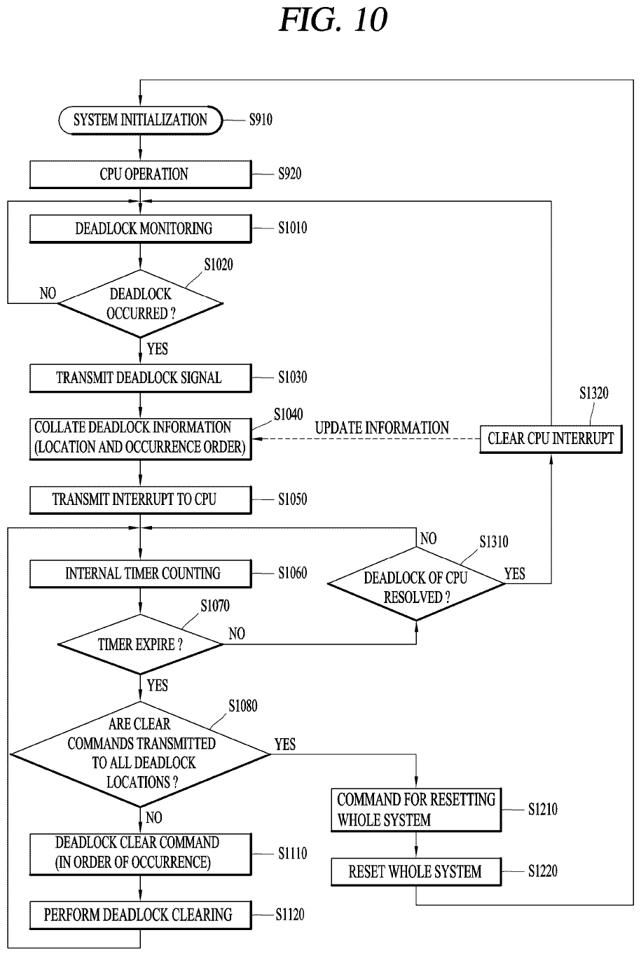

FIG. 10 illustrates a flowchart of a recovery method for resolving a system deadlock according to this specification. Referring to FIG. 10, the recovery method may be configured to include a deadlock monitoring process (S1010), a deadlock determination process (S1020), a deadlock occurrence signal transmission process (S1030), an interrupt transmission process (S1050), a deadlock resolution command transmission process (S1110), and a deadlock resolving process (S1120). The recovery method may further include system initialization (S910) and a CPU operation process (S910) prior to the deadlock monitoring process (S1010).

Referring to FIGS. 5 to 10, the recovery method for resolving a system deadlock is described in detail. After a system resetting process (S1220) is performed, an operation of initializing the system may be performed through the system initialization (S910). The system initialization (S910) may be performed by entire components of the system, and all components that interoperate with the system reset block 1500 and other components that interoperate with all the components may be initialized. After the system initialization (S910) is performed, operation of the CPU 1300 may be performed by interoperating with other components after completion of booting by the CPU in the CPU operation process (S910).

In the deadlock monitoring process (S1010), the recovery block 1100 may monitor deadlock occurrence in the system. Through the deadlock determination process (S1020), the deadlock manager block 1200 may receive a deadlock occurrence signal from the recovery block 1100 to determine whether a deadlock has in a system occurred. In this regard, whether a deadlock has occurred in the recovery block 1100 may be monitored and determined with respect to all paths that may cause a CPU deadlock. When the deadlock in the system has occurred, the recovery block 1100 may generate and transmit a deadlock occurrence signal to the deadlock manager block 1200 in the deadlock occurrence signal transmission process (S1030).

Through the interrupt transmission process (S1050), when the deadlock occurrence signal is received from the recovery block 1100, the deadlock manager block 1200 may transmit an interrupt to the central processing unit (CPU) 1300. This is a process in which the deadlock manager block 1200 transmits an interrupt to the CPU 1300 to notify of a deadlock situation when deadlock detection information is transmitted from the recovery block 1100.

Through the deadlock resolution command transmission process (S1110), the deadlock manager block 1200 may determine that the CPU 1300 is in a deadlock state when the internal timer expires, and transmit a deadlock resolution command to the recovery block 1100. This may be performed depending on whether deadlock clearing commands have been transmitted to all deadlock occurrence locations collected and collated in the deadlock manager block 1200. This is to check whether a deadlock is not resolved even after deadlock clearing has been attempted at all the deadlock occurrence locations.

Through the deadlock resolving process (S1120), when the deadlock resolution command is received, the recovery block 1100 may control to resolve a deadlock of a corresponding interface associated with the deadlock resolution command. In addition, a corresponding function block associated with the deadlock resolution command may be controlled to be isolated from the system bus. In this regard, clearing commands may be transmitted to the deadlock occurrence locations collected and aggregated by the deadlock manager block 1200, in an order of deadlock occurrences. A reason why the clearing commands are transmitted in the order of the deadlock occurrences is that when a first cause of a deadlock in association of the deadlock occurrences is resolved, other causes are likely to be resolved naturally.

Meanwhile, after the deadlock occurrence signal transmission process (S1030), the recovery method may further include performing a deadlock occurrence information collection process (S1040). In the deadlock occurrence information collection process (S1040), information regarding deadlock occurrence locations in which deadlocks have occurred and an order of deadlock occurrences may be collected.

Meanwhile, after the interrupt transmission process (S1050), the recovery method may further include an internal timer counting process (S1060), an internal timer expiration determination process (S1070), and a deadlock resolution command transmission completion determination process (S1080). In the internal timer counting process (S1060), the deadlock manager block 1200 may control the internal timer to operate and count valid time of a timer until the timer expires. The internal timer for determining whether a deadlock situation has been resolved may be operated by the deadlock manager block 1200.

In the internal timer expiration determination process (S1070), the internal timer of the deadlock manager block 1200 may be counted and whether the internal timer has expired may be determined by comparing to timer expiration time. Through the internal timer expiration determination process (S1070), whether the deadlock has been resolved until the internal timer expires may be determined. In the deadlock resolution command transmission completion determination process (S1080), whether deadlock resolution commands have been transmitted to all the occurrence locations in an order of occurrences may be determined.

Meanwhile, after the interrupt transmission process (S1050) is performed, the recovery method may further include a deadlock resolution determination process (S1310) and an interrupt clearing process (S1320). In this regard, before the internal timer expires in the internal timer expiration determination process (S1070), the deadlock resolution determination process (S1310) may be performed. In the deadlock resolution determination process (S1310), whether a deadlock of the recovery block has been resolved and the CPU is operable may be determined. In this regard, whether a deadlock of the CPU has been resolved may be determined. In detail, depending on whether a deadlock situation is resolved before the internal timer expires, either recounting of the internal timer or clearing of the interrupt by the CPU may be performed. Whether the deadlock situation has been resolved may be checked through a signal transmitted from the recovery block 1100 or information transmitted by the CPU after the deadlock situation has been resolved.

When it is determined that the deadlock of the recovery block 1100 has been resolved and the CPU 1300 is operable, the CPU 1300 may perform a system recovery service routine in the interrupt clearing process (S1320). Accordingly, the CPU 1300 may clear the interrupt of the deadlock manager block 1200.

A corresponding functional block in which a deadlock has occurred may be the first recovery block 1110a operably connected to the first master block 1410a among the plurality of master blocks. Meanwhile, in the deadlock resolution determination process (S1310), the deadlock manager block 1200 may perform subsequent operations depending on whether the deadlock of the first recovery block 1110a has been resolved but the interrupt of the deadlock manager block 1200 has not been cleared. When the interrupt of the deadlock manager block 1200 is not cleared and the internal timer of the deadlock manager block 1200 expires again, it may be determined that the CPU 1300 is still in a deadlock state. Accordingly, a second deadlock resolution command may be transmitted to the second recovery block 1110b to which a second deadlock signal has been transmitted, and the internal timer may be controlled to reoperate. Meanwhile, the second recovery block 1110b may be operably coupled to the second master block 1410b among the plurality of master blocks. As another example, a second deadlock signal may be generated according to detection of a second deadlock that has occurred in another slave block, for example, the first slave block 1420a. Accordingly, the first slave block 1420a and the second recovery block 1120a may be operably coupled to each other.

In the deadlock resolution command transmission process (S1110), until the performing of the system recovery service routine by the CPU 1300 is completed, the deadlock manager block 1200 may repeatedly transmit a plurality of deadlock resolution commands to a plurality of recovery blocks. In the deadlock resolution command transmission completion determination process (S1080), the deadlock manager block 1200 may determine that a system recovery attempt has failed when a plurality of deadlock resolution commands are transmitted to all of the plurality of recovery blocks in which deadlocks have occurred.

As described above, after the deadlock occurrence signal transmission process (S1030), a deadlock occurrence information collection process (S1040) of collecting information regarding deadlock occurrence locations in which deadlocks have occurred and an order of deadlock occurrences may be performed. Meanwhile, after the interrupt transmission process (S1050), the internal timer expiration determination process (S1070) of determining whether the internal timer has expired by counting the internal timer of the deadlock manager block 1200 may be performed. In addition, the deadlock resolution command transmission completion determination process (S1080) of determining whether deadlock resolution commands have been transmitted to all occurrence locations in an order of occurrences may be further performed.

After the deadlock resolving process (S1120) is performed, the internal timer expiration determination process (S1070) may be repeatedly performed until the CPU 1300 becomes operable in the deadlock resolution determination process (S1310). In the internal timer expiration determination process (S1070), when the deadlock of the CPU has not been resolved and it is determined that the internal timer has expired, the deadlock resolution command transmission completion determination process (S1080) may be performed. In the deadlock resolution command transmission completion determination process (S1080), it may be determined whether deadlock resolution commands have been transmitted to all deadlock occurrence locations in which deadlocks have occurred.

Meanwhile, when the transmission of the resolution command is completed in the deadlock resolution command transmission completion determination process (S1080), the recovery method may further include performing a system reset command transmission process (S1210) and the system resetting process (S1220). When it is determined that the deadlock resolution commands have been transmitted to all the occurrence locations in which the deadlocks have occurred, a system reset command may be transmitted to the system reset block 1500 in the system reset command transmission process (S1210). By transmitting the system reset command to the system reset block 1500, resetting of all blocks in a whole system may be performed by rebooting all the blocks in the system resetting process (S1220).

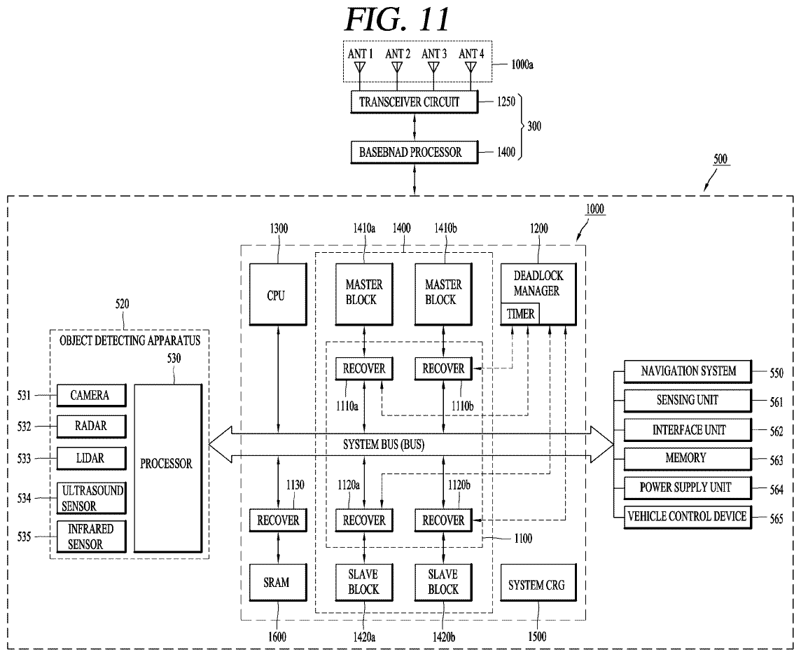

Meanwhile, the recovery device that resolves a system deadlock according to this specification may be equipped in a vehicle. In this regard, FIG. 11 illustrates a configuration of a vehicle that interoperates with the recovery device according to this specification. Referring to FIG. 11, communication may be performed with peripheral electronic devices, vehicles, and infrastructure through an antenna module and a transceiver.

Referring to FIG. 4 and FIG. 11, the processor 570 of the vehicle 500 may be configured as a recovery device 100 that resolves a deadlock of an internal system of the vehicle according to this specification. In this regard, the processor 570 may be a processor of a car area network (CAN) or advanced driving assistance system (ADAS), but is not limited thereto. When the vehicle 500 is implemented in a distributed control manner, the processor 570 of the vehicle 500 may be replaced with a processor of each device.

Referring to FIG. 11, the antenna module 1000a may be mounted in the vehicle. The antenna module 1000a may perform short-range communication, wireless communication, V2X communication, and the like by itself or through the communication device 400 of FIG. 4. The communication device 400 of FIG. 4 may be implemented with a transceiver circuit 1250 and a baseband processor 1400 of FIG. 11, or may be implemented with a separate communication module or hardware chip. The baseband processor 1400 may perform control such that a signal is received from or transmitted to the adjacent vehicle, the RSU, and the base station through the antenna module 1000a.

The baseband processor 1400 may perform control such that a signal is received from or transmitted to the adjacent vehicle, the RSU, the adjacent object, and the base station through the communication device 400. Here, the information related to adjacent objects may be acquired through an object detecting apparatus 520, such as the camera 531, the radar 532, the LiDar 533, and the sensors 534 and 535 of the vehicle 500. The baseband processor 1400 may perform control such that a signal is received from or transmitted to an adjacent vehicle, an RSU, an adjacent object, or a base station through the communication device 400 and the antenna module 1000a. The recovery device 1000 that recovers a system deadlock may interoperate with the object detecting apparatus 520 via the system bus BUS. The recovery device 1000 may interoperate with at least one among a navigation system 550, a sensing unit 561, an interface unit 562, a memory 563, a power supply unit 564, or a vehicle control device 565 via the system bus BUS.

Referring to FIGS. 1 to 11, the vehicle 500 having the antenna module 1000a may include the plurality of antennas 1100, the transceiver circuit 1250, and the baseband processor 1400. The vehicle 500 may further include the object detection device 520. The vehicle 500 may further include the communication device 400. Here, the communication device 400 may be configured to perform wireless communication through the antenna module.

The vehicle 500 may include an antenna assembly 1000a. The antenna module 1000a may perform communication with at least one of an adjacent vehicle, a road side unit (RSU), and a base station through the processor. The antenna module 1000a may perform telematics operations through wireless communication in the vehicle, and thus may also be referred to as a telematics module.

The transceiver circuit 1250 may be operably coupled to the antenna module 1000a to perform wireless communications with other wireless devices of FIG. 2. The processor 1400 may be operably coupled to the transceiver circuit 1250. The processor 1400 may be a baseband processor corresponding to a modem, but is not limited thereto and may be any processor that controls the transceiver circuit 1250. The processor 1400 of the vehicle may be implemented as a network access device (NAD) and may be referred to as a wireless communication control element.

The processor 1400 may be operably coupled to the transceiver circuit 1250 and may be configured to control the transceiver circuit 1250. The processor 1400 may control the transceiver circuit 1250 to control the amplitude and/or phase of the signals transmitted to the first to fourth antennas ANT1 to ANT4 in the antenna module 1000a or to operate only some antennas. The processor 1400 may perform communication with at least one of the adjacent vehicle, the RSU, and the base station through the transceiver circuit 1250.

In a case where there is a need to simultaneously receive information from various entities such as the adjacent vehicle, the RSU, and the base station for autonomous driving, etc., information may be received and transmitted through MIMO. Accordingly, the vehicle may improve its communication capacity by receiving different information from various entities at the same time. Therefore, the communication capacity of the vehicle may be improved through the MIMO without increasing a bandwidth.

Alternatively, the vehicle may simultaneously receive the same information from various entities, so as to improve reliability of surrounding information and decrease latency. Accordingly, URLLC (Ultra Reliable Low Latency Communication) may be performed in the vehicle and the vehicle may operate as a URLLC UE. To this end, a base station that performs scheduling may preferentially allocate a time slot for the vehicle operating as the URLLC UE. For this, some of specific time-frequency resources already allocated to other UEs may be punctured.

The plurality of antennas ANT1 to ANT4 for 4G/5G communications within the antenna module 1000a may operate in the full band including the low band (LB), the mid band (MB), and the high band (HB). Here, the low band (LB) may be referred to as the first (frequency) band and the mid band (MB) and the high band (HB) may be referred to as the second (frequency) band. As another example, when the antenna system 1000 operates in the mid band (MB) and the high band (HB), the middle band (MB) is referred to as a first (frequency) band and the high band (HB) is referred to as a second (frequency) band. The 5G Sub6 band may be the same band as the LTE band in case of LTE re-farming. When 5G NR operates in a band separate from LTE, it may operate in the high band (HB) or a higher band. The 5G Sub6 band operating in the high band (HB) or higher band may also be referred to as a second (frequency) band.

The baseband processor 1400 may perform MIMO through some of the plurality of antennas ANT1 to ANT4 in the first frequency band. Also, the baseband processor 1400 may perform MIMO through some of the plurality of antennas ANT1 to ANT4 in the second frequency band. In this regard, the baseband processor 1400 may perform MIMO by using antenna elements that are sufficiently spaced apart from each other and arranged by being rotated at a predetermined angle. This may improve isolation between the first and second signals within the same band.

The baseband processor 1400 may control the transceiver circuitry 1250 to receive the second signal of the second frequency band while receiving the first signal of the first frequency band through one of the first to fourth antennas ANT1 to ANT4. In this case, there is an advantage that the baseband processor 1400 may perform carrier aggregation (CA) through one antenna.

Alternatively, the baseband processor 1400 may control the transceiver circuitry 1250 to receive the first signal of the second band through any one of the second antenna ANT2 and the fourth antenna ANT4 while receiving the first signal of the second band through any one of the first antenna ANT1 and the third antenna ANT3. In this case, there may be an advantage in that each antenna may be designed to optimally operate in a corresponding band.

Therefore, the baseband processor 1400 may perform carrier aggregation (CA) through a combination of the first frequency band and the second frequency band. When it is necessary to receive a large amount of data for autonomous driving or the like, reception in a broad band may be allowed through the CA.

Accordingly, enhanced mobile broad band (eMBB) communication may be performed in the vehicle and the vehicle may operate as an eMBB UE. To this end, a base station performing scheduling may preferentially allocate broadband frequency resources for the vehicle operating as the eMBB UE. To this end, the CA may be performed on frequency bands that are available, except for frequency resources already allocated to other vehicles.

Regard the frequency band, the low band (LB), the mid band (MB), and the high band (HB) may be referred to as the first band, the second band, and the third band, respectively. The antenna system 1000 may operate as a single antenna in the first band, the second band, and the third band corresponding to the low band (LB), the middle band (MB), and the high band (HB). In this regard, the processor 1400 may determine a resource region allocated through a physical downlink control channel (PDCCH). The processor 1400 may control the transceiver circuit 1250 to perform carrier aggregation in two or more of the first to third bands based on the allocated resource region.

The processor 1400 may perform MIMO in an EN-DC state through the first to fourth antennas ANT1 to ANT4. For example, the processor 1400 may perform an EN-DC operation through the first antenna ANT1 and the second antenna ANT2, and MIMO through the third antenna ANT3 and the fourth antenna ANT4.

In this regard, when the EN-DC operation is performed between the 4G/5G communication systems and the WiFi communication system using different bands, the processor 1400 may perform the EN-DC operation through a plurality of antennas in one antenna system. Accordingly, an interference level between MIMO streams using the same band may be reduced. In some examples, when the EN-DC operation is performed between the 4G and 5G communication systems using the same band, the processor 1400 may perform the EN-DC operation through a plurality of antennas in different antenna systems. In this instance, to reduce the interference level in the low band (LB), the MIMO operation through the plurality of antennas in the same antenna system may be performed in the mid band (MB) or higher.

The recovery device and method for resolving a system deadlock have been described above. Hereinafter, technical effects of the recovery device and method which resolve a system deadlock are described.

According to this specification, a problem such that an entire scenario operation needs to be performed again because continuity with previous operations is lost due to initialization of a whole system may be solved.

According to this specification, when a system is initialized due to a deadlock, continuity with previous operations may be preserved at maximum.

According to this specification, an issue such that it is difficult to maintain continuity of operations due to a limited amount of preserved information caused by resource problems in storage spaces according to storage of intermediate states at particular intervals during performance of all operations may be resolved.

According to this specification, an issue such that an intermediate state storage process increases overhead of a central processing unit may be solved.

According to this specification, a central processing unit may be independently protected from being brought into a deadlock state so that the central processing unit may attempt a system recovery without having to reset a whole system.

According to this specification, a method of providing information to identify a cause of a deadlock may be proposed.

According to this specification, when system recovery may be executed through a central processing unit instead of using a method of initializing a whole system in the related art, continuity of operations may be preserved and a function loss section due to system initialization may be minimized.

Further scope of applicability of the disclosure will become apparent from the foregoing detailed description. It should be understood, however, that the detailed description and specific examples, such as the preferred embodiment of the disclosure, are given by way of illustration only, since various changes and modifications within the spirit and scope of the disclosure will be apparent to those skilled in the art.

In relation to the present disclosure described above, a recovery device for resolving a system deadlock in a vehicle and an operation of controlling the recovery device may be implemented by software, firmware, or a combination thereof. Meanwhile, the recovery device for resolving a system deadlock and a configuration performing a control operation of the recovery device may be implemented as computer-readable codes in a program-recorded medium.

The computer-readable medium may include all types of recording devices each storing data readable by a computer system. Examples of such computer-readable media may include hard disk drive (HDD), solid status disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may also include a controller of a terminal or vehicle, namely, a processor. Therefore, the detailed description should not be limitedly construed in all of the aspects, and should be understood to be illustrative. The scope of the disclosure should be determined by reasonable interpretation of the appended claims and all changes that come within the equivalent scope of the disclosure are included in the scope of the disclosure.

1. A recovery device configured to resolve a system deadlock in a vehicle, the recovery device comprising:
a recovery block that generates and transmits a deadlock occurrence signal when a deadlock in a system occurs;
a deadlock manager block that transmits an interrupt and operates an internal timer to wait for a particular operation to be completed, upon receiving the deadlock occurrence signal from the recovery block; and
a central processing unit (CPU) operably coupled to a system bus and configured to receive the interrupt from the deadlock manager block and clear the interrupt in an operational state,
wherein the deadlock manager block comprises:
a deadlock information module configured to collect occurrence locations and an order of deadlock occurrences of the deadlock transmitted from the recovery block; and
a deadlock clear module configured to transmit a deadlock resolution command in the order of deadlock occurrences,
wherein the deadlock manager block determines that the CPU is in a deadlock when the internal timer expires, transmits the deadlock resolution command configured to transmit in the order of deadlock occurrences of the occurrence locations to the recovery block, and
when the deadlock resolution command is received, the recovery block resolves a deadlock of a corresponding interface associated with the deadlock resolution command and controls a corresponding function block associated with the deadlock resolution command to be isolated from the system bus.

2. The recovery device of claim 1, wherein the corresponding function block is a first recovery block operably connected to a first master block among a plurality of master blocks, and
when it is determined that the deadlock of the first recovery block is resolved and the CPU is operable, the CPU performs a system recovery service routine and clears the interrupt of the deadlock manager block.

3. The recovery device of claim 2, wherein the deadlock manager block is configured to:
determine that the CPU is still in a deadlock, when the deadlock of the first recovery block is resolved but the interrupt of the deadlock manager block is not cleared and the internal timer of the deadlock manager block expires again; and
transmit a second deadlock resolution command to a second recovery block to which a second deadlock signal has been transmitted, and control the internal timer to re-operate, and
the second recovery block is operably coupled to a second master block among the plurality of master blocks.

4. The recovery device of claim 3, wherein until the CPU completes the performing of the system recovery service routine, the deadlock manager block repeatedly transmits a plurality of deadlock resolution commands to a plurality of recovery blocks, and
when the plurality of deadlock resolution commands are transmitted to all of the plurality of recovery blocks in which deadlocks have occurred, the deadlock manager block determines that a system recovery attempt has failed.

5. The recovery device of claim 4, wherein, when the performing of the system recovery service routine by the CPU is not completed even after deadlock resolution commands are transmitted to all of a plurality of master blocks and all of a plurality of slave blocks in which deadlocks have occurred, the deadlock manager block determines that the system recovery attempt has failed.

6. The recovery device of claim 4, wherein, when it is determined that the system recovery attempt has failed, the deadlock manager block transmits a system reset command to a system reset block to reboot all blocks in a whole system to reset all the blocks.

7. The recovery device of claim 1, wherein the recovery block is a master recovery block operably connected to a particular master block among a plurality of master blocks, and
the master recovery block is operably coupled to the particular master block through a command channel via which a command is received from the particular master block and a response channel via which a response is transmitted to the particular master block.

8. The recovery device of claim 7, wherein the master recovery block comprises:
a first buffer interfaced with the command channel and a second buffer interfaced with the response channel;
a virtual command generation module operably coupled to the first buffer to generate a deadlock occurrence signal;
a virtual response reception module operably coupled to the second buffer to receive a command received from the system bus; and
a deadlock clear control module operably coupled to the first buffer and the second buffer, and configured to receive first control commands associated with a deadlock resolution command from the deadlock manager block.

9. The recovery device of claim 8, wherein the master recovery block further comprises:
a command monitor module operably coupled to the first buffer and the system bus, and configured to monitor control commands transmitted through the command channel;
a response monitor module operably coupled to the second buffer and the system bus and configured to monitor responses transmitted through the response channel; and
a deadlock detection module which is operably coupled to the command monitor module and the response monitor module, and detects a deadlock of the system and transmits a deadlock occurrence signal to the deadlock manager block.

10. The recovery device of claim 9, further comprising a slave recovery block operatively connected to a particular slave block among a plurality of slave blocks,
wherein the slave recovery block is operably coupled to the system bus through a command channel via which a command is received from the system bus and a response channel via which a response is transmitted to the system bus.

11. The recovery device of claim 10, wherein the slave recovery block comprises:
a third buffer interfaced with the command channel and a fourth buffer interfaced with the response channel, the third buffer and the fourth buffer being operably coupled to the particular slave block;
a virtual command reception module operably coupled to the third buffer and configured to receive a control command associated with the deadlock occurrence signal;
a virtual response generation module operably coupled to the fourth buffer and configured to generate a response associated with the deadlock occurrence signal; and
a deadlock clear control module operably coupled to the third buffer and the fourth buffer, and configured to receive second control commands associated with a deadlock resolution command from the deadlock manager block.

12. The recovery device of claim 11, wherein the slave recovery block further comprises:
a command monitor module operably coupled to the third buffer and the system bus, and configured to monitor control commands transmitted through the command channel;
a response monitor module operably coupled to the fourth buffer and the system bus and configured to monitor responses transmitted through the response channel; and
a deadlock detection module which is operably coupled to the command monitor module and the response monitor module, and detects a deadlock in the system to transmit a deadlock occurrence signal to the deadlock manager block.

13. The recovery device of claim 12,
wherein the deadlock information module is configured to receive a deadlock occurrence signal from the deadlock detection module of the master recovery block and receive a deadlock occurrence signal from the deadlock detection module of the slave recovery block; and
the deadlock clear module configured to transmit control commands associated with the deadlock resolution command to the deadlock clear control module of the master recovery block and transmit second control commands associated with clearing of the deadlock to the deadlock clear control module of the slave recovery block.

14. A recovery method for resolving a system deadlock in a vehicle, the recovery method comprising:
a deadlock monitoring process of, by a recovery block, monitoring occurrence of a deadlock in a system;
a deadlock determination process of, by a deadlock manager block, receiving a signal of the deadlock occurrence from the recovery block and determining whether the deadlock has occurred in the system;
a deadlock occurrence information collection process of collecting occurrence locations and an order of deadlock occurrences of the deadlock transmitted from the recovery block;
a deadlock occurrence signal transmission process of, by the recovery block, generating and transmitting a deadlock occurrence signal when the deadlock in the system occurs;
an interrupt transmission process of, by the deadlock manager block, transmitting an interrupt to a central processing unit (CPU), upon receiving the deadlock occurrence signal from the recovery block;
a deadlock resolution command transmission process of, by the deadlock manager block, determining that the CPU is in a deadlock when an internal timer expires, and transmitting the deadlock resolution command configured to transmit in the order of deadlock occurrences of the occurrence locations to the recovery block; and
a deadlock resolving process of, by the recovery block, resolving a deadlock of a corresponding interface associated with the deadlock resolution command upon receiving the deadlock resolution command, and controlling a corresponding function block associated with the deadlock resolution command to be isolated from the system bus.

15. The recovery method of claim 14, further comprising:
after the interrupt transmission process,
a deadlock resolution determination process of determining whether the deadlock of the recovery block has been resolved and the CPU is operable; and
an interrupt clearing process of, by the CPU, performing a system recovery service routine and clearing an interrupt of the deadlock manager block when it is determined that the deadlock of the recovery block has been resolved and the CPU is operable.

16. The recovery method of claim 15, wherein the corresponding function block is a first recovery block operably connected to a first master block among a plurality of master blocks, and
in the deadlock resolution determination process, the deadlock manager block is configured to:
determine that the CPU is still in a deadlock when the deadlock of the first recovery block has been resolved but the interrupt of the deadlock manager block is not cleared and the internal timer of the deadlock manager block expires again;
transmit a second deadlock resolution command to a second recovery block to which a second deadlock signal has been transmitted, and control the internal timer to re-operate; and
the second recovery block is operably coupled to a second master block among the plurality of master blocks.

17. The recovery method of claim 16, wherein, in the deadlock resolution command transmission process, the deadlock manager block repeatedly transmits a plurality of deadlock resolution commands to a plurality of recovery blocks until the CPU completes the performing of the system recovery service routine, and
in a deadlock resolution command transmission completion determination process, the deadlock manager block determines that a system recovery attempt has failed when the plurality of deadlock resolution commands are transmitted to all of the plurality of recovery blocks in which deadlocks have occurred.

18. The recovery method of claim 15,
wherein the recovery method further comprises:
after the interrupt transmission process,
an internal timer expiration determination process of determining whether the internal timer has expired, by counting the internal timer of the deadlock manager block; and
a deadlock resolution command transmission completion determination process of determining whether deadlock resolution commands have been transmitted to all the occurrence locations according to the order of the occurrence.

19. The recovery method of claim 18, wherein, after the deadlock resolving process is performed, the internal timer expiration determination process is repeatedly performed until the CPU becomes operable in the deadlock resolution determination process, and
when it is determined that the deadlock of the CPU has not been resolved and the internal timer has expired in the internal timer expiration determination process, it is determined in the deadlock resolution command transmission completion determination process whether the deadlock resolution commands have been transmitted to all of the occurrence locations in which the deadlocks have occurred.

20. The recovery method of claim 19, further comprising:
after the deadlock resolution command transmission completion determination process,
a system reset command transmission process of transmitting a system reset command to a system reset block when it is determined that the deadlock resolution commands have been transmitted to all of the occurrence locations in which the deadlocks have occurred; and
a system resetting process of transmitting the system reset command to the system reset block to reboot all blocks in a whole system to reset all the blocks.
